(19) United States
(12) Patent Application Publication
(10) Pub. No.: US 2007/0145070 A1
(43) Pub. Date: Jun. 28, 2007

(54) Flow control device for dispenser of refrigerator

(76) Inventors: Gwan Ho Ro, Seoul (KR); Young Sik Nam, Suwon (KR)

Correspondence Address: Dykema Gosset PLLC;Franklin Square, Third Floor West, 1300 I Street, N.W., Washington, DC, 20005-3353, US

(21) Appl. No.: 11/542,548

(22) Filed: Oct. 4, 2006

(30) Foreign Application Priority Data
Dec. 22, 2005 (KR) 2005-127698

(51) Int. Cl. B67D 5/30

(52) U.S. Cl. 222/14

(57) ABSTRACT

Disclosed is a dispenser installed on a door of a refrigerator to dispense a liquid or an ice. The dispenser for the refrigerator supplies a fluid to a fluid container or an ice maker from a fluid supply member W through an operation process of a plurality of supply lines and regulation valves. An outlet line of the fluid container is divided into a main outlet line and an auxiliary outlet line, in which the main outlet line and the auxiliary outlet line are equipped with a main switching button and the auxiliary switching button, respectively, which are operated in response to an output signal of a flow rate measuring device. The discharge amount of the fluid can be constantly maintained by selecting either of the main outlet line and the auxiliary outline provided in the fluid container of the refrigerator, irrespective of the pressure in the fluid supply system, thereby improving its use convenience and solving the inconvenience of overflowing and delay.

### BACKGROUND OF THE INVENTION

1. Field of the Invention

The present invention relates to a dispenser installed on a door of a refrigerator to dispense a liquid or an ice, and more particularly, to a flow control device for a dispenser of a refrigerator which regulates a discharge flow rate of a fluid by use of a plurality of channels provided in the dispenser thereby to improve its use convenience.

2. Background of the Related Art

Generally, a large refrigerator is provided with a dispenser for supplying a fluid or an ice to a user at the outside of the refrigerator, with a door being not opened. Such a dispenser prevents a heat loss of the refrigerator by shielding escape of a chill from the refrigerator, and does not lead to user inconvenience due to opening of the door.

More specifically, referring to FIGS. 1 and 2, a dispenser 100 includes an ice switch 110 and a fluid switch 120, which are mounted on the door of a refrigerator. If the ice switch 110 or the fluid switch 120 is operated, an ice maker 280 or a fluid container 270 is opened, so that an ice or fluid is discharged from an ice outlet port 130 or a fluid outlet port 140.

Referring to FIG. 2, a fluid supply system 200 of the dispenser 100 is operated by the fluid supplied through a first supply line 210 connected to a fluid supply member W, such as a faucet, the operation of which will now be described hereinafter.

The fluid supplied to a first supply line 210 flows through a first control valve 220, so that a flow rate of the fluid is regulated by the first control valve 220. Then, after the fluid is purified through a filter 230, the fluid is divided into two parts by first and second pipe lines 250 and 260.

Next, the fluid supplied to the first pipe line 250 is supplied to the fluid outlet port 140 through the fluid container 270, while the fluid supplied to the second pipe line 260 is supplied to the ice outlet port 130 through the ice maker 280.

Referring to FIG. 3, the fluid container 270 is equipped with one discharge line 275, and a switching button 277 which is operated by the fluid switch 120 and is returned by a resilient spring 276 is mounted on the discharge line 275.

When a cup is positioned in a cup receiving portion of the dispenser 100 and the fluid switch 120 is pushed with the cup, the discharge line 275 of the fluid container 270 is opened by the switching switch 277. As a result, the fluid filled in the fluid container 270 is supplied to the fluid outlet port 140, and thus the user takes the fluid purified by the filter 230.

The flow rate to be discharged from the fluid outlet port 140 is determined depending upon the pressure of the fluid supply member W. Consequently, much fluid may be discharged and overflow the cup in case a little fluid is required. Otherwise, if much fluid is required, the fluid switch 120 is pushed for a long time.

### SUMMARY OF THE INVENTION

Accordingly, the present invention is directed to a dispenser for a refrigerator that substantially obviates one or more problems due to limitations and disadvantages of the related art.

An object of the present invention is to provide a dispenser for a refrigerator capable of regulating a discharge flow rate of a fluid by use of a plurality of channels provided in the dispenser thereby to improve its use convenience.

To achieve the object and other advantages, according to one aspect of the present invention, there is provided a dispenser for a refrigerator for supplying a fluid to a fluid container or an ice maker from a fluid supply member through an operation process of a plurality of supply lines and regulation valves, wherein an outlet line of the fluid container is divided into a main outlet line and an auxiliary outlet line, in which the main outlet line and the auxiliary outlet line are equipped with a main switching button and the auxiliary switching button, respectively, which are operated in response to an output signal of a flow rate measuring device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a conventional dispenser installed in a refrigerator;

FIG. 2 is a view illustrating an operation system of a conventional dispenser;

FIG. 3 is a cross-sectional view illustrating an operation system of a conventional dispenser;

FIG. 4 is a plan view illustrating an operation system of a dispenser according to the present invention; and

FIG. 5 is a cross-sectional view illustrating a flow control device installed in a dispenser according to the present invention.

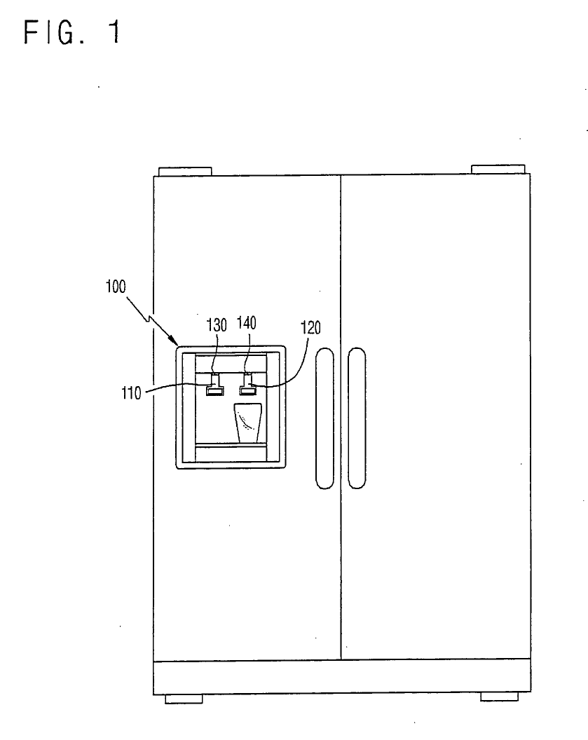

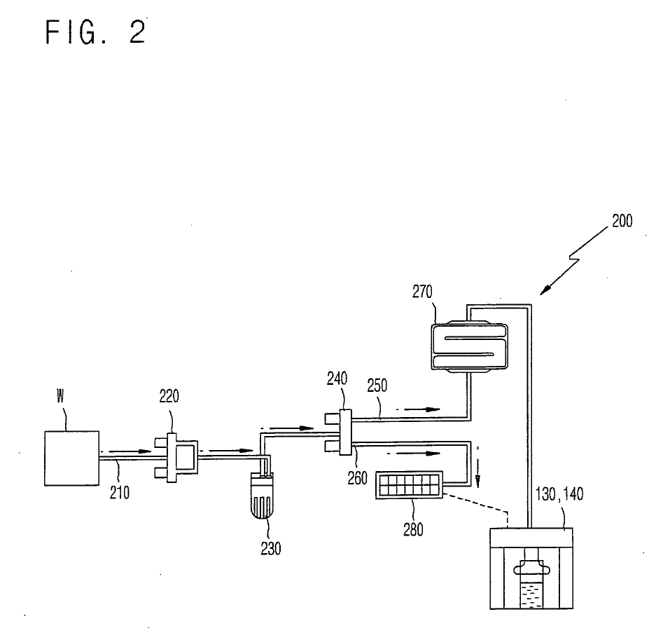

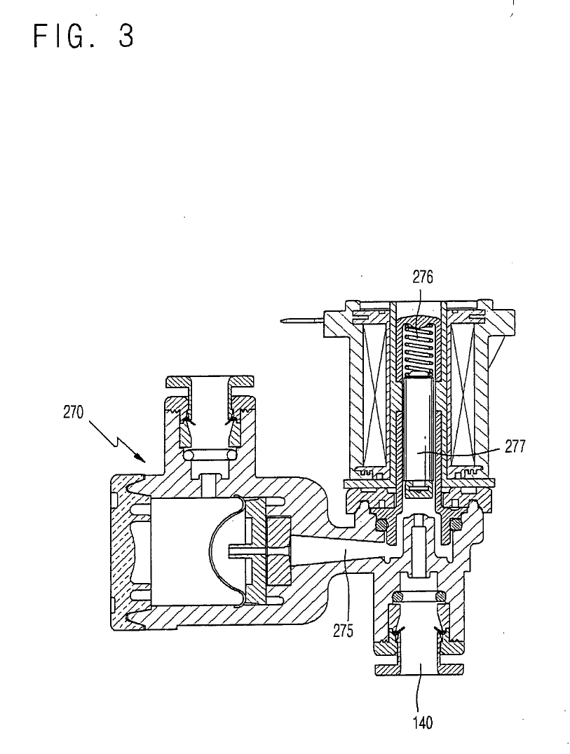

### DETAILED DESCRIPTION OF THE PREFERRED EMBODIMENTS

A preferred embodiment according to the present invention will now be explained with reference to the accompanying drawings.

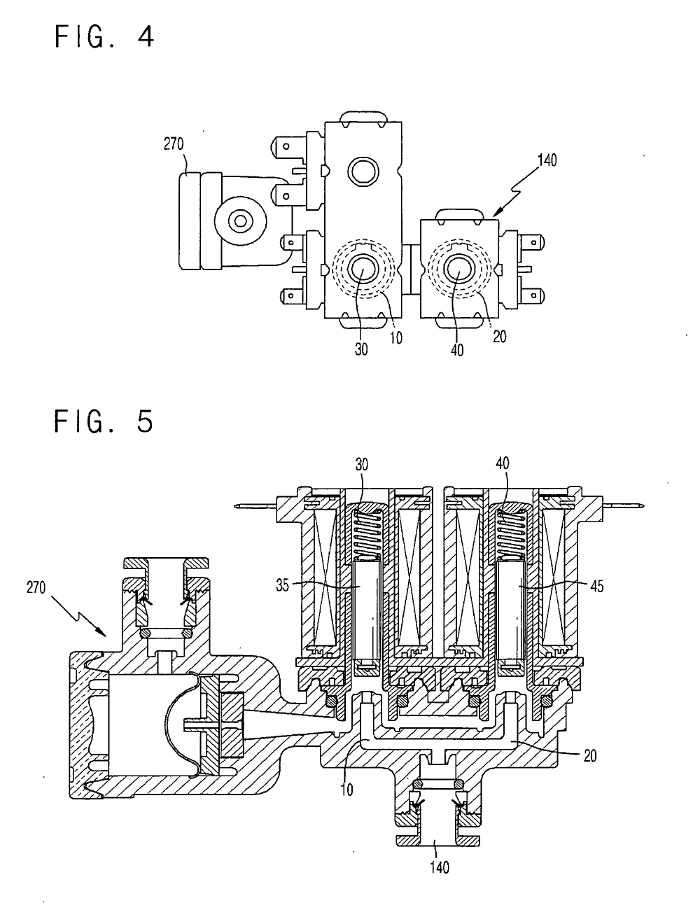

FIG. 4 is a plan view illustrating an operation system of a dispenser according to the present invention, and FIG. 5 is a cross-sectional view illustrating a flow control device installed in the dispenser according to the present invention. The dispenser for a refrigerator supplies a fluid to a fluid container 270 or an ice maker 280 from a fluid supply member W through an operation process of a plurality of supply lines and regulation valves. An outlet line of the fluid container 270 is divided into a main outlet line 10 and an auxiliary outlet line 20. The main outlet line 10 and the auxiliary outlet line 20 are equipped with a main switching button 35 and the auxiliary switching button 45, respectively, which are operated in response to an output signal of a flow rate measuring device. Either of the main switching button 35 and the auxiliary switching button is selectively operated in response to the signal of the flow rate measuring device.

The dispenser 100 and the fluid supply system 200 according to the present invention are similar to those of the prior art, except for a flow control device provided between the fluid container 270 and the fluid outlet port 140. Therefore, the dispenser 100 and the fluid supply system 200 will not be described in detail herein.

In this embodiment, the dispenser 100 and the fluid supply system 200 are designated by the same reference numerals as those of the prior art described above.

In addition, although the present invention relates to the fluid supply system 200 provided with a first supply line 210, a filter 230, first and second regulation valves 220 and 240, first and second pipe lines 250 and 260, a fluid container 270, and an ice maker 280, the present invention can be applied to any fluid supply system of other refrigerator capable of supplying a fluid or ice.

The fluid container 270 is to supply the fluid to the fluid outlet port 140 by pumping the purified fluid from the fluid supply system 200. The fluid container 270 includes the main outlet line 10 and the auxiliary outlet line 20, which connect the fluid outlet port 140 with a discharge line.

In addition, the outlet port of the main outlet line 10 and the outlet port of the auxiliary outlet line 20 are connected to the fluid outlet port 140.

The main outlet line 10 has an inner diameter slightly larger than that of the auxiliary outlet line 20 so that the discharge amount of the fluid is different from each other.

The main switching button 35 is mounted on the main outlet line 10, and is moved up and down by a resilient spring 30. Also, an auxiliary switching button 45 is mounted on the auxiliary outlet line 20, and is moved up and down by a resilient spring 40.

The main and auxiliary switching buttons 35 and 45 are raised in response to an electric signal, and are turned by the resilient springs 30 and 40.

Preferably, the main/auxiliary switching buttons 35 and 45 are formed in a rod shape so that the buttons are smoothly moved up and down.

Although the present invention employs the main and auxiliary switching buttons 35 and 45 made of an electromagnet, other construction selectively opening and closing the main outlet line 10 and the auxiliary outlet line 20 in accordance with an external signal can be utilized.

A flow rate measuring device (not shown) is mounted in a discharge passage of the fluid supply member W, that is, a discharge passage of the fluid container 270, to detect the flow rate of the fluid supplied from the fluid supply member W. The flow rate measuring device outputs an operation signal to the main switching button 35 and/or the auxiliary switching button 45.

The operation of the dispenser according to the present invention will now be described.

First, when the fluid switch 120 is pushed with the cup positioned in a cup receiving portion so as to obtain the fluid from the dispenser 100, the main switching button 35 is operated in accordance with the output signal of the flow rate measuring device, so that the fluid flows through the main outlet line 10.

Specifically, if the signal detected by the flow rate measuring device is a predetermined value, only the main switching button 35 is operated to maintain the discharge amount of the fluid at a constant level.

If the signal detected by the flow rate measuring device is below a determined value, the main switching button 35 and the auxiliary switching button 45 are simultaneously operated so that the fluid flows through the main outlet line 10 and the auxiliary outlet line 20.

Otherwise, if the signal detected by the flow rate measuring device is above a determined value, only the auxiliary switching button 45 is operated to regulate the discharge amount of the fluid.

As described above, according to the flow control device of the dispenser for the refrigerator of the present invention, the discharge amount of the fluid can be constantly maintained by selecting either of the main outlet line and the auxiliary outline provided in the fluid container of the refrigerator, irrespective of the pressure in the fluid supply system, thereby improving its use convenience and solving the inconvenience of overflowing and delay.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

1. A dispenser for a refrigerator for supplying a fluid to a fluid container or an ice maker from a fluid supply member through an operation process of a plurality of supply lines and regulation valves, wherein
an outlet line of the fluid container is divided into a main outlet line and an auxiliary outlet line, in which the main outlet line and the auxiliary outlet line are equipped with a main switching button and an auxiliary switching button, respectively, which are operated in response to an output signal of a flow rate measuring device; and
either of the main switching button and the auxiliary switching button is selectively operated in response to the signal of the flow rate measuring device.
